(19) United States
(12) Patent Application Publication
(10) Pub. No.: US 2007/0084998 A1
(43) Pub. Date: Apr. 19, 2007

(54) Novel tandem mass spectrometer

(75) Inventors: Jochen Franzen, Bremen (DE); Carsten Stoermer, Bremen (DE); Bruce Reinhold, Sudbury, MA (US)

Correspondence Address: LAW OFFICES OF PAUL E. KUDIRKA, 40 BROAD STREET, SUITE 300, BOSTON, MA, 02109, US

(73) Assignee: Bruker Daltonik GmbH, Bremen (DE)

(21) Appl. No.: 11/505,237

(22) Filed: Aug. 16, 2006

(30) Foreign Application Priority Data
Aug. 22, 2005 (DE) 10 2005 039 560.0

(51) Int. Cl. H01J 49/00

(52) U.S. Cl. 250/287

(57) ABSTRACT

In a tandem mass spectrometer ions are created only once and stored in an ion reservoir. A particular ion species to be analyzed is then exported from the reservoir through a mass selective ion gate without damaging the other ion species remaining in the reservoir. All subsequent analyses are conducted on these stored ions, without adding further ions so that no changes in the concentrations of the stored ion species occur. The exported ions are fragmented, and a fragment ion mass spectrum is measured in a mass analyzer, preferably in a time-of-flight mass analyzer with orthogonal ion injection. The processes of exporting a selected ion species with subsequent fragmentation and the acquisition of the fragment ion spectrum can be repeated for any number of ion species stored in the reservoir.

### FIELD OF THE INVENTION

The invention relates to tandem mass spectrometers (abbreviated herein as “MS/MS”), i.e., to mass spectrometers which can acquire mass spectra from fragment ions of a selected ion species and thus determine the quantity and the mass of the fragment ions.

### BACKGROUND OF THE INVENTION

Over the past four decades, tandem mass spectrometry has developed into an extraordinarily successful branch of mass spectrometry. A tandem mass spectrometer (MS/MS) first filters out a preselected ion species from a constant supply of an ion mixture in the form of a continuous ion beam, fragments this selected ion species, and measures the spectrum of the fragment ions in a mass analyzer. The ions of the selected ion species are frequently called “parent ions”, the fragment ions are then correspondingly called “daughter ions”.

In the course of time, two fundamentally different types of tandem mass spectrometry have developed, termed “tandem in space” and “tandem in time”.

“Tandem in space” is the term used for a method which uses a mass filter (i.e., a first mass spectrometric separation system) as the mass selective device, a spatially separate chamber for the fragmentation of the ions selected and a mass analyzer (a second mass spectrometric separation system), which is again spatially separate, to acquire the spectrum of the daughter ions. The use of two mass spectrometric separation systems has led to the abbreviation MS/MS. In the beginning of tandem mass spectrometry, magnetic sector fields were regularly used as mass filters; nowadays RF quadrupole mass filters are used almost exclusively (except with so-called TOF/TOF instruments). As mass analyzers, several types of mass spectrometers can be used, including mass spectrometers with magnetic sector fields, RF quadrupole mass spectrometers, ion cyclotron resonance mass spectrometers, and time-of-flight mass spectrometers with orthogonal ion injection. In the “tandem in space” method, however, the selecting mass filter only admits one single ion species of analytical interest at a given time, while all other ion species of the ion mixture are destroyed and lost to further analysis.

The “tandem in time” method consists in conducting all the steps of selection, fragmentation and analysis of the daughter ions in a single cell, an ion trap, in a stepwise time sequence. As is the case with “tandem in space”, only the species of parent ion which is of analytical interest is retained at the selection step; all other ion species are destroyed and lost forever. The ion traps used here can be linear RF quadrupole ion traps with four pole rods, three-dimensional RF quadrupole ion traps with a ring electrode and two end cap electrodes, or the cells of ion cyclotron resonance mass spectrometers. This “tandem in time” method makes it relatively easy to repeat the selection and fragmentation steps and therefore to not only measure daughter ion spectra, but also granddaughter ion spectra or even great-granddaughter ion spectra.

The destruction of all ion species not immediately required for analysis is not unfavorable as long as only one single ion species in a sample is to be analyzed. If, by contrast, several or even a large number of substances, each possibly having many ion species, are to be analyzed, then this destruction is a waste of sample material and therefore very unfavorable.

The importance of tandem mass spectrometry lies in the fact that acquiring the fragment ion spectra provides insight into the structure of the parent ions selected, on the one hand, and on the other enables a true and reliable identification of the type of the parent ions. In biological sciences it particularly enables sequences in biopolymers to be determined (or at least parts of these sequences and also modifications of these sequences), particularly amino acid sequences in proteins and peptides. The importance of tandem mass spectrometry has further increased because the special ionization methods for biomolecules, especially electrospray ionization (ESI) and ionization by matrix-assisted laser desorption (MALDI), are extraordinarily gentle (so-called “soft” ionization methods) and supply practically no fragment ions themselves, as was the case with the early ionization methods such as electron impact ionization. The soft ionization methods supply only so-called pseudo-molecular ions, usually protonated or deprotonated molecules, which only provide information about the mass of the molecule, but no further information concerning the identity and structure of the molecule. Because there are millions of bio-substances, even a very precise mass measurement does not uniquely identify the substance. Further information is therefore required for the reliable identification of a substance, and this information is provided almost exclusively by tandem mass spectrometry. Even if the aim is “only” a quantitative determination of a substance being sought which is actually known, a reliable identification, and therefore the use of tandem mass spectrometry, is indispensable in bio-analysis.

Particularly important for tandem mass spectrometry is the fragmentation of the ions selected. For proteins and peptides it has now turned out that there are essentially two fundamentally different types of fragmentation of these biopolymers. These two types of fragmentation provide sets of information which are independent of each other (often termed “orthogonal” methods), and a comparison of the fragment ion spectra produced by the two types of fragmentation provides particularly valuable additional information.

The first type of fragmentation is a decomposition of the parent ions after they have collected sufficient internal energy from one or several energy absorption processes. The internal energy here is distributed broadly over all internal oscillation systems of the parent ions, but the localization of the energy changes constantly because the oscillation systems are coupled and therefore continuously exchange energy among themselves. If, at a certain bond of the parent ion, a force finally occurs which exceeds the bonding force, then the parent ion breaks here into two fragments. Statistically, the fragmentations only affect those bonds with low binding energies. In the case of proteins, this type of decomposition mainly leads to so-called b and y fragment ions. The energy can be collected from a large number of moderate collisions (CID=collision induced decomposition), or by absorbing a large number of infrared quanta (IRMPD=infrared multi photon decomposition).

A modification of this is the so-called high energy collisionally induced fragmentation (HE-CID). With collisions in the region of kinetic energies of a few kiloelectronvolts, one collision is sufficient to lead to fragmentation. The fragment spectra generated in this way look somewhat different from those of low energy processes because they contain more spontaneous fragmentations, for example breaking off side chains, and also more subsequent fragmentations and therefore more fragment ion signals in total. They are more difficult to interpret and tend therefore to be avoided. Basically, however, these high energy fragment ion spectra of proteins also contain predominantly b and y fragment ions.

The second type of decomposition is brought about by an electron transfer to multiply positively charged parent ions; the decomposition is spontaneous and leads predominantly to so-called c and z fragment ions. The electron transfer can be performed by direct capture of an electron (ECD=electron capture dissociation), by transfer of an electron of a suitable negatively charged ion (ETD=electron transfer dissociation), or by the transfer of an electron from a highly excited neutral atom to the parent ion (MAID=metastable atom induced decomposition).

Commercial tandem mass spectrometers exhibit always a relatively low sensitivity for the measurement of a multitude of substances from a sample, since to select one ion species for further preparation through to the analysis of its fragment ions, all other ion species have always been destroyed and are no longer available for further analysis. For the analyses of further ion species or further substances of the same sample, more sample has to be used up to generate new ions every time. Since for many biochemical problems, only very little sample material is available, the tandem mass spectrometers available until now have been unfavorable. The desired objective of many molecular biologists is to be able to determine the proteome of a single cell consisting of only some 10⁸ protein molecules. Even if the original sample material is available in large quantities, analyte substances of interest can be present in such extremely small quantities that, after extracting them with a suitable mixture of antibodies, for example, only very few analyte molecules are available to determine the relative concentrations. To give an example, the concentration of 20 to 30 different interleukins that are extraordinarily interesting from a medical point of view, amounts to only some 10 to 100 attomols per milliliter in each case. In an extract of 100 milliliters, the quantities of interleukins are therefore only just enough to be detected, not sufficient for today's MS/MS analysis.

The selection of one ion species according to its mass and the isolation of the selected species, however, do not necessarily have to involve destruction of all other ions. It is also possible to transfer the ions of a selected ion species from one ion storage device into another ion storage device without destroying the ions which are not selected. It has been known for a long time that ions can be transferred mass selectively from a first ion cyclotron resonance cell into a second, the ions not transferred remaining in the first cell. The mass selective transfer of ions from an RF quadrupole ion trap into a neighboring one has also been described. Generally speaking, ions can be mass selectively ejected from ion traps by means of resonance processes without destroying the ions which remain behind; the ion traps here can be two-dimensional RF ion traps with four pole rods, or three-dimensional RF ion traps with ring electrode and end cap electrodes, or ion cyclotron resonance cells. This is the basic principle of all ion trap mass spectrometry with external ion detection, where one ion species is always ejected mass selectively for measurement, the remaining ions being left in the ion trap and not destroyed.

A relatively simple method for the mass selective transfer of ions without destroying all other ions can be found in U.S. Pat. No. 6,177,668 B1 (J. W. Hager). This describes a method with mass selective axial ejection at the end of an RF pole rod system. The ejection of the ions is brought about by excitation of the ion's radial oscillation in the fringe field at the end of the pole rod system: “Trapped ions are axially mass selectively ejected by taking advantage of the mixing of the degrees of freedom induced by the fringing fields and other anti-harmonicities in the vicinity of the end lens. Thus, ions can be mass selectively ejected at the exit end at the same time as ions are being admitted into the entrance end of the rod set, thereby taking better advantage of the ion flux from a continuous ion source” (cited from the patent abstract). This mass selective ejection of the ions ejects the ions, in this patent, onto an ion detector, i.e., it itself acts as a mass analyzer. Measuring the ejected ion species in a mass scan one after the other results in a mass spectrum. The invention of the Hager patent focuses on a novel ion trap mass spectrometer using this mass scan with a high duty cycle of the ions used. With this method, it is possible to achieve a satisfactorily high mass resolution, but at the price of a very slow scan speed. Scanning of the mass spectra takes a long time; for example (according to the data from the aforementioned Hager patent), a mass spectrum over 3000 mass units for a mass resolution of R=6000 requires a total measuring time of 24 seconds. Moreover, in one scan only a relatively small proportion of the ions (in the order of between five and twenty percent) are ever ejected from the ion trap.

In his patent, however, J. W. Hager describes not only the use of this ion ejection in the fringe field as a mass spectrometric fundamental principle, he also already uses the principle as a mass selector for the selection of parent ions for subsequent fragmentation, but always in conjunction with the same type of ion trap mass spectrometry with axial ion ejection as the mass analyzer for the fragment ions and always in conjunction with a constant influx of ions from an ion source. This patent does not recognize the general significance of this principle as a mass selector for tandem mass spectrometry in general, and for the analysis of the ions in a closed store of ions, in particular.

This type of ion mass selective gate, which can be used to transport ions of a selected small mass range from one ion storage device into another without destroying the ions which are not selected, is henceforth simply termed an “ion gate”.

Whenever the term “mass of the ions” or simply “mass” is used here in connection with ions, it is always the “charge-related mass” m/z which is meant, i.e., the physical mass m of the ions divided by the dimensionless and absolute number z of the positive or negative elementary charges which this ion carries. In the usual scientific language, the term “mass spectrometry” always means “charge-related mass spectrometry” or “m/z spectrometry”, since it's always only the charge-related mass, which is measured by mass spectrometry.

The term “analysis” of an ion species or a substance is defined here to include both the determination of the quantity relative to other ion species or other substances (“quantitative analysis”), as well as the determination of the identity of the ion species or substance (“qualitative analysis”) via further measurements, for example measurements of the internal structure of the ions. It furthermore may include the determination of the structure of the ion species itself. In the case of biopolymers, the term “analysis” may also include the determination of the sequence of the modified or unmodified polymer building blocks of the ions of one ion species (“structural analysis”, “sequential analysis”, “modification analysis” etc.).

### SUMMARY OF THE INVENTION

The basic idea of the invention is to first ionize a sample, to store the ions in a storage reservoir, to close the storage reservoir, and to analyze stored ion species one after the other by fragmenting the ions and acquiring fragment ion spectra, whereby the ions are extracted from the storage reservoir by a mass selective ion gate without destroying the remaining ions.

In the method according to the invention, ions of a sample are thus first generated and stored in a storage reservoir. The storage reservoir is preferably located inside the vacuum system, and filled with some pure damping gas at pressures in the range from 10⁻² to 10⁺² Pascal. When the storage reservoir has been filled with sufficient numbers of ions, or when the whole sample has been ionized, the further supply of ions is prevented in order not to change the concentration ratios in the storage reservoir during the forthcoming analyses of the various substances of the sample. If the ion source is arranged outside the vacuum, the introduction aperture for the ions, which also allows ambient gas into the mass spectrometer, can, for example, be sealed by a special device. It can also be sufficient, however, to simply stop any further ionization by switching off voltages.

After completing the filling of the storage reservoir, a first parent ion species is now selected to be analyzed. These parent ions are now exported through a mass selective ion gate out of the first storage reservoir without destroying other ions in the storage reservoir. During this process, as few other ion species as possible should be exported, i.e., the exported mass range should be as small as possible. The exported ions are then fragmented in one of the usual ways and the fragment ions are analyzed in a mass analyzer with a high mass resolution and a high duty cycle for the ions by acquiring the fragment ion mass spectrum.

The method can then be repeated for other ion species of the first analyte substance and for any number of ion species of the other analyte substances without having to constantly generate new ions from new sample material, as is the case with the tandem mass spectrometers which are usual today. Other ion species of the same analyte substance can be ions with a different charge state, for example triply charged ions instead of doubly charged ones, other ions of the isotope group, or ions of other digest peptides of the analyte proteins. The fragment ion spectra can finally be used to determine the identities, the concentrations or the structures of all the analyte substances under investigation. According to the rules of good laboratory practice, for quantitative determinations the analyte substances should also include reference substances of a known type and concentration, which serve to determine concentrations, and can also be used to constantly monitor the performance of the method. The method should have been calibrated beforehand for the analyte substances.

The storage reservoir can also be equipped with devices to inject negative ions or to add reactant gases of various types, in order to be able to use ion-ion reactions or ion-molecule reactions to bring about specific desired modifications to the ion population before the analyte substances are analyzed. Examples of such reactions are the reduction of the charges of highly charged ions (“charge stripping”), or the substitution of hydrogen with deuterium.

In principle, almost any type of mass spectrometer which was initially designed as a mass analyzer for tandem mass spectrometers can be used as a mass analyzer. However, a particularly favorable type here is a time-of-flight mass spectrometer with orthogonal ion injection, since it provides fast spectrum acquisition, high mass accuracy, high mass range, good utilization of the ions (“duty cycle”) and high dynamic range of measurement at comparatively low production costs. Relatively unfavorable, by contrast, are quadrupole mass analyzers and magnetic sector field mass analyzers since they again act as mass filters, only filtering out one ion species after the other for a measurement and in the meantime destroying all other ion species.

### BRIEF DESCRIPTION OF THE DRAWINGS

The above and further advantages of the invention may be better understood by referring to the following description in conjunction with the accompanying drawings in which:

FIG. 1 is a schematic diagram of an example of a tandem mass spectrometer constructed in accordance with the principles of the invention, with a nanoelectrospray ion source, an inlet capillary, a closing mechanism for the inlet capillary, an ion funnel, a first storage reservoir, whose end forms the ion gate, with a set of coaxial apertured diaphragms, the first of which is slit for the excitation of the selected ion species for export (not visible in the schematic representation), a second storage reservoir, which here also serves as the collision cell for the fragmentation of the exported ions, and a time-of-flight mass analyzer, consisting of a lens system to form a fine ion beam, pulser, reflector and ion detector.

FIG. 2 illustrates a cross section through the end of the storage reservoir with four pole rods and four auxiliary electrodes.

FIGS. 3, 4 and 5 illustrate forms of the first apertured diaphragm at the end of the quadrupole rod system; this apertured diaphragm is slit to excite the ion species selected. In FIG. 3 the diaphragm is cut in a cruciform shape for a circumpolar excitation, in FIGS. 4 and 5 it has a simple slit for conventional and diagonal excitation respectively.

FIGS. 6 and 7 depict cross sections through rod systems where either the form or positioning of one pole rod essentially superimposes a hexapole field onto the quadrupole RF field in the interior.

FIG. 8 illustrates a cross section through a rod system where the form of two pole rods essentially superimposes an octopole multipole field onto the quadrupole RF field in the interior.

FIG. 9 illustrates how two interconnected auxiliary electrodes in a rod system which provides a hexapole superposition (see FIG. 6) generate a favorable dipolar excitation with an alternating excitation voltage.

### DETAILED DESCRIPTION

The method of the invention relates to quantitative, qualitative or structural analysis of at least one analyte substance in complex mixtures, and comprises the steps:
a) ionizing a sample of the complex mixture,
b) storing the sample ions in a storage reservoir,
c) stopping any further filling of the storage reservoir,
d) exporting selected ion species of one of the analyte substances from the storage reservoir through an ion gate, whereby the ion gate essentially exports only the ions of a selected, small mass range and leaves the other ions undamaged in the reservoir,
e) fragmenting the exported ions,
f) acquiring a mass spectrum of the fragment ions in a mass analyzer, and
g) repeating steps d) to f) for other ion species of the same substance or from other substances of the sample.

In this invention a sample (or partial sample) is completely ionized and the ions are stored in a sufficiently large storage reservoir without further ions being allowed into the storage reservoir during the analytical processes for the various constituents of the sample, in order to not change the concentration of the various ions inside the storage reservoir. The ion gate is used only for the selective transfer of the ions into an adjacent storage reservoir.

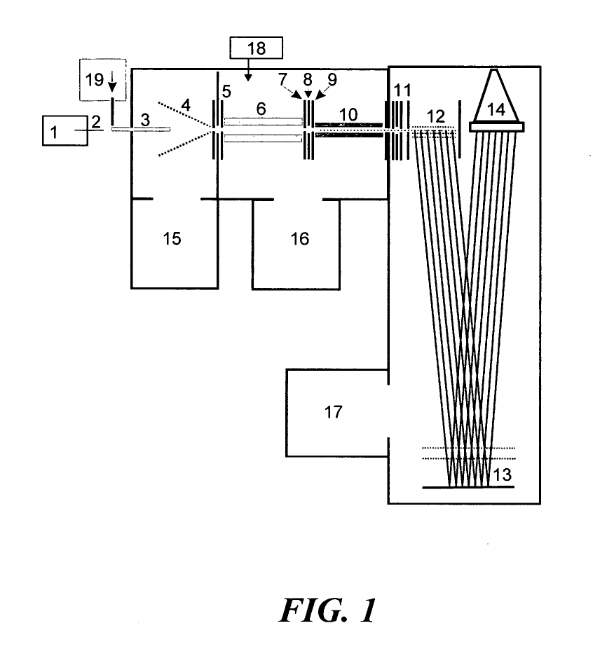

FIG. 1 is a schematic diagram of one embodiment of a tandem mass spectrometer in accordance with the principles of the invention and comprises a nanoelectrospray ion source (1,2), an inlet capillary (3), a closing mechanism (19) for the inlet capillary (3), an ion funnel (4), a first storage reservoir (6), whose end forms the ion gate, with a set of coaxial apertured diaphragms (7, 8, 9), the first of which (7) is slit for the excitation of the selected ion species for export (not visible in FIG. 1), a second storage reservoir (10), which here also serves as the collision cell for the fragmentation of the exported ions, and a time-of-flight mass analyzer, consisting of a lens system (11) to form a fine ion beam, pulser (12), reflector (13) and ion detector (14).

The storage reservoirs (6) and (10) can be constructed in various forms, a part of the walls always having a structure made of electrodes, across which the phases of an RF voltage form a pseudo-potential that repels ions of both polarities and can thus confine them in the storage reservoir. The basics of such a storage reservoir are described in U.S. Pat. No. 5,572,035 A (J. Franzen). Part of the walls can also carry electrodes with an ion-repelling DC potentials, but in this case only ions of a single polarity can be stored. This limitation is not unfavorable, however, since ions of different polarity stored at the same time only react with each other and would thus largely destroy each other. Particularly favorable here are relatively simple storage reservoirs, which have long been known and which are constructed as hexapole, or preferably quadrupole, rod systems with terminal coaxial apertured diaphragm systems. The most favorable form of storage reservoir depends to a large extent on the type of ion gate used.

There are various types of mass selective ion gates. They are generally based on an, at least initial, resonant dipolar excitation of the ions to oscillatory motions, and therefore require a chamber in which the ions can execute oscillations as a result of retroactive centripetal forces. Thus, for example, selected parent ions within a quadrupole rod system, which can act as the first storage reservoir (6), can be mass selectively ejected in a radial direction from slits in the pole rods by resonant dipolar excitation of their secular oscillations, then trapped in an ion funnel and forwarded to a fragmentation chamber. This ejection leads to the ejected ions having high kinetic energies, however. Similarly, ions can be mass selectively ejected from a three-dimensional ion trap with ring electrode and two end cap electrodes without damaging the remaining ions. This mass selective export of ions is the basis of all mass analyses with ion traps.

An essentially different type of such a mass selective ion gate is again based on a quadrupole field between four pole rods, but exports the selected parent ions axially into a second storage reservoir; see the J. W. Hager patent, cited above. This type of ion gate is fundamentally based on the presence of three characteristics: Firstly, there must be a local change in the strength of the RF quadrupole field, which necessarily generates force components of the pseudo-potential in axial direction; secondly, there must be a device for the resonant excitation of the selected ion species in radial direction; and thirdly, a weak DC barrier transverse to the axial direction must prevent the passage of the ions from the first storage reservoir into a second as long as the ions do not receive additional energy.

The local change of the quadrupole field can, for example, be formed by a localized change to the cross section of the rod system, for example by millings, grooves or holes in the pole rods, and particularly simple by the fringing field at the end of the rod system. In this case, an ion lens made of apertured diaphragms can form the DC barrier. If, for example, the first apertured diaphragm of this ion lens is split transversely, then it can also carry out the radial excitation of the parent ions. In other embodiments, either the DC barrier or the dipolar excitation or both can be brought about by auxiliary electrodes between the pole rods of the quadrupole system.

At the location of a change of the quadrupole field, for example in the fringing field at the end of the pole rod system, axial components of the electric pseudo-field exist outside the axis. If the parent ions selected are radially excited resonantly at this location, then, as their radial oscillations increase, they increasingly experience the force of the axial component of the pseudo-field, which is directed axially outwards, and this enables them to overcome the DC barrier and enter the second, adjacent storage reservoir. If the radial excitation continues, the parent ions selected are continuously transported into the second storage reservoir, and their concentration in the first storage reservoir in front of the ion gate continuously decreases. The diffusion of the ions in the axial direction provides a continuous supply of ions to the ion gate.

Different embodiments of this axial ion gate are discussed below; they are distinguished by the type of radial excitation of the ion species selected and by different designs of the pole rod system.

The novel tandem mass spectrometer according to the invention comprises at least
(a) an ion source to ionize the sample,
(b) a storage reservoir for the ions of the sample,
(c) a device to stop the filling of the storage reservoir,
(d) an ion gate which exports ions of a selected small mass range from the storage reservoir and leaves the other ions undamaged in the storage reservoir,
(e) a fragmentation device for the exported ions and
(f) a mass analyzer to scan the mass spectrum of the fragment ions.

If the design of the vacuum system is appropriate, it is quite possible for the ions in the storage reservoir to remain almost unchanged for periods of many minutes; but depending on the cleanness of the vacuum system and the purity of the damping and collision gas which is fed in, it is not possible to completely prevent interfering changes to the ions, mainly in the form of partial discharging ions with higher charges, over longer periods of time in the order of half or full hours. However, since the tandem mass spectrometer according to the invention is to be used for the analysis of a large number of ion species, for example for the analysis of 20 to 200 ion species which can belong some 5 to 20 digested proteins, it is certainly favorable, possibly even necessary, to use a fast mass analyzer to acquire the fragment ion spectra, in order to keep the whole analysis time short. A mass analyzer here is to be considered as “fast” if it can acquire at least one complete fragment ion spectrum per second. It is then possible to analyze many analyte substances in relatively few minutes. It is also favorable if the mass analyzer has a high mass resolving power (for example R=m/Δm>6,000) to have a clear separation of the ion peaks up to 3000 atomic mass units. Moreover, it is favorable if it has a high mass range for the acquisition the fragment spectra so that it can, for example, acquire fragment ion spectra over the range of around 50 to 3000 atomic mass units. Furthermore, the mass analyzer should make effective use of the ions by a high duty cycle. A preferred mass analyzer is a time-of-flight mass spectrometer with orthogonal ion injection.

Since the capacity of any ion storage device is limited, and since high space charges cause large separations of ions of different charge-related masses, making it more difficult to sample ions in proportion to their concentration, the first storage reservoir can also have a device for removing such ion species that occur particularly frequently but are of no interest for the analytical objective. This increases the dynamic measuring range of this new tandem mass spectrometer.

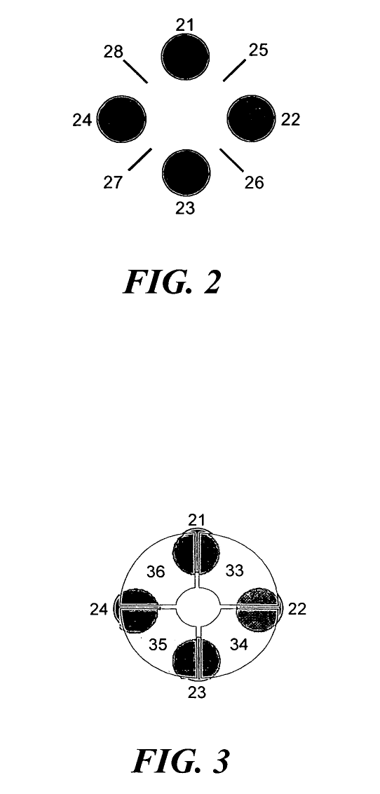

One preferred embodiment of the first storage reservoir (6) uses a quadrupole rod system some 20 centimeters long made of four simple round rods (21, 22, 23, 24 shown in FIG. 2) with a separation of approx. two centimeters. Hyperbolic rods are also possible, but not absolutely necessary. At the ends of the pole rod system (6) there are sets of coaxial apertured diaphragms (5, 7, 8, 9) to which DC voltages can be applied and which can thus keep the ions of a desired polarity in the interior of the rod system (6) by means of counter-voltages. The chamber around the rod system is filled by a supply tank (18) with a non-reactive damping gas, for example with helium, but other light damping gases such as ultrapure nitrogen are also possible. When the pressure in the quadrupole storage reservoir (6) is around 10⁻² Pascal, all motion of the ions, including their oscillations transverse to the axis, is damped within a few milliseconds to such an extent that the ions collect in the longitudinal axis of the rod system (6). They do not become completely motionless, however, but still move with at least thermal energies and this diffusion motion causes them to continuously mix, at least in the axial direction.

The optimal cross section of the quadrupole rod system (6) for the storage reservoir depends greatly on the precise type of ion gate used and can only be discussed in conjunction with the function of this ion gate. FIGS. 2, 6, 7 and 8 illustrate different types of cross section.

It has long been known that ions in three-dimensional ion traps made of a ring electrode and two end cap electrodes, and also in other forms of ion storage devices can be stored over relatively long periods of time (many minutes) without significant losses, although after even longer times slight modifications to the ions, particularly reductions of the ion charges, are observed. For a hexapole storage device in the ultrahigh vacuum region of an FTICR mass spectrometer, see, for example: “A Gated-beam Electrospray Ionization Source with an External Ion Reservoir. A New Tool for the Characterization of Biomolecules Using Electrospray Ionization Mass Spectrometry”, Steven A. Hofstadler et al., Rapid Commun. Mass Spectrom., 13, 1971-1979 (1999).

A large volume quadrupole rod system (6) can accept between 10⁸ and 10¹⁰ ions before it overflows. It is not advisable, however, to fill it with so many ions because the ions then separate to great distances in a radial direction in the interior, making it more difficult to sample the ions in proportion to their concentrations. Light ions collect in the axis, heavy ions are forced a long way toward the outside by the space charge because the retroactive pseudoforces of the quadrupole RF field are smaller for these heavier ions than for lighter ones. The population of ions should therefore be limited to between roughly 10⁶ and a maximum of 10⁸ ions. If the pole rod system is long enough, around 10⁷ ions can collect in the axis of the pole rod system in a string-shaped cloud which just exceeds about one millimeter in diameter, whereby the ions of all charge-related masses can be sampled with roughly the same probability. Here too, the light ions are inside, very close to the axis, and the heavier ions outside; but all ions can be accessed relatively well by a dipolar excitation field and resonantly excited to oscillations transverse to the axis.

The storage reservoir should be operated with a damping gas in the pressure range of approx. 10⁻³ to 1 Pascal, preferably between 10⁻¹ and 10⁻² Pascal, in order to damp the motion of the stored ions. The damping gases used include noble gases such as helium or argon, and also ultrapure nitrogen. The molecules of these low molecular weight or noble gases cannot react with the ions because their reaction affinities, and their proton affinities in particular, are too low. The damping gas and the underlying ultrahigh vacuum must, however, be free from substance vapors with higher molecular weights, since these can react in a variety of ways with the stored ions. The most frequent reaction process here is proton transfer from multiply positively charged analyte ions to the impurity molecules. This reduces the charge state of the analyte ions; so-called “charge stripping” occurs. The creation of new ions of the impurity substances here is not as damaging as the reduction in the concentration of the multiply charged analyte ions, which are very favorably used as the parent ions for fragmentation. According to the rules of ultrahigh vacuum systems (UHV), the vacuum system must therefore be manufactured from suitable materials such as metal and ceramic and have appropriate cleaning methods. If helium is used as the damping gas, it is generally ultrapure; the supply lines and pressure reducer must be correspondingly thoroughly laid and kept clean.

Ions of the same polarity cannot react with each other because their charges mean they repel each other; their relatively low kinetic energy therefore means that they cannot get as close to each other as is necessary for chemical reactions. The only reactions which are possible, therefore, are those with ions of the other polarity or with neutral particles.

In a favorable embodiment, wire or blade-shaped electrodes (25-28) can be mounted between each of the four round rods (21-24). These electrodes are termed “auxiliary electrodes” below; they can be split, particularly in the longitudinal direction, into different separate sections which are isolated from each other, or they can only cover specific sections. By applying different DC and AC voltages across these auxiliary electrodes, or by voltage drops across different auxiliary electrode sections along the axis, it is possible to achieve different types of effect. A DC barrier can be set up, for example, or the ion cloud in the interior can be mixed or moved in the longitudinal direction. Preselected ion species can be excited by dipolar AC voltages applied across two opposed auxiliary electrodes (for example 25 and 27) in order to export them through an ion gate, for example, or to eject undesirable ions from the reservoir transverse to the axis. This type of ion ejection is favorable if the ion mixture consists predominantly of a small number of ion species which are not of interest analytically but which form the major part of the space charge. Ejecting all ions of these few highly concentrated ion species makes it possible to fill the ion reservoir (6) with the ions that are of analytical interest so that ions at very low concentrations can also be measured.

The storage reservoir is preferably filled with ions from an ion source (1, 2) through a coaxial apertured diaphragm system (5) at one end. The ion source can be located inside or outside the vacuum system.

Especially favorable here is a special modification of an electrospray ion source, called a nanoelectrospray ion source, which operates outside the vacuum system (for example, as described in U.S. Pat. No. 5,504,329 (M. Mann and M. Wilm)). This ion source is loaded with a few microliters of a dissolved sample located in a minute capillary (2) which extends to a fine tip. The diameter of the tip aperture is only some four micrometers. An electric spray voltage of around one kilovolt draws the liquid out to a Taylor cone from whose tip a continuous current of very small charged droplets flies off. These droplets are dried in a warm to hot counterflow of pure ambient gas, for example ultrapure nitrogen. After drying the microdroplets, multiply charged ions of the dissolved substances generally remain behind. These ions are introduced into the vacuum system in the usual way; for example, they can be drawn into the vacuum through an inlet capillary (3) with ambient ultrapure nitrogen. They are liberated from the drawn-in ambient gas in the vacuum system in several differential pump stages and stored in the ion reservoir. Ion funnels (4) (such as those described in U.S. Pat. No. 6,107,628 (R. D. Smith and S. A. Shaffer)) are particularly good for separating off the ambient gas. With the aid of such a device it is possible to store around 106 ions per second in the storage reservoir. An optimal filling can therefore be completed in approx. 10 to 100 seconds, provided that ions which are not of interest are not continuously ejected from the storage reservoir again in order to increase the dynamic range of measurement.

After filling the storage reservoir, the influx of further ions is prevented so that there is no change in the concentrations for the subsequent analyses. This step is a significant part of the invention. The influx is automatically prevented when the sample is completely used up, but this can also be achieved by simply lowering the spray voltage of the nanoelectrospray ion source, for example. It is more favorable, however, to prevent the influx of ambient gas (ultrapure nitrogen, for instance), and hence the influx of trace impurities as well, by closing the inlet capillary (3) by means of a special closing device (19). The nitrogen is then evacuated in the interior of the mass spectrometer in a few seconds. It is then possible to work with any suitable gas, for instance very clean helium, as the collision and damping gas in the interior of the mass spectrometer, completely independent of the choice of the ambient gas of the nanoelectrospray ion source.

Of course, it is also possible to use other types of ion sources either inside or outside the vacuum system, including MALDI. It is particularly favorable to use the nanoelectrospray (1, 2), however, because it provides a high ion yield per molecule used and a high proportion of multiply charged ions of the substances. These multiply charged ions are particularly suitable for a formation of fragment ions with high informational value.

In this first storage reservoir (6), the ions can be prepared for further analysis in a wide variety of ways. Ion species which occur frequently and which are not of interest for the analytical objective can be ejected from the store, as already indicated above. This can occur by means of a strong resonant excitation by the auxiliary electrodes (25-28), for example. It can also be brought about by a resonant excitation voltage applied across two opposed pole rods (for example 21, 23) themselves. These ions can, finally, also be removed through the ion gate itself. The removal can be undertaken during the filling so that the reservoir is never overfilled at any time.

It is sometimes the case that reactive modifications of the ions in the storage reservoir are desirable. They can be produced in the storage reservoir by arbitrarily introducing suitable reactant gases. One example here is an exchange of hydrogen atoms of the ions with deuterium atoms; many types of derivatization of the ions with chemical groups are also possible, however. By introducing ions of opposite polarity it is possible to reduce the charge state of highly charged ions (“charge stripping”), e.g., to reduce ions with between five and twenty positive charges down to two to three charges per ion by injecting negative ions which can accept protons, for example. If negative ions are admitted which easily give up electrons, then large, multiply positively charged proteins can already be split in this storage reservoir by “electron transfer dissociation”. The ions of the other polarity can be generated, for example, from a suitably chosen material solution by the same electrospray ion source (1, 2) with a spray voltage of opposite polarity and can then be analogously introduced through the ion funnel (4) and the set of apertured diaphragms (5) into the storage reservoir (6), where they react, even if the storage reservoir is not set up for the permanent storage of ions of this polarity.

A preferred embodiment of an ion gate uses the fringing field at the end of the quadrupole storage reservoir (6) to provide the axial components of the pseudo-field which serves to export selected parent ions into an adjacent second storage reservoir. At the exit of the rod system of the first storage reservoir, an ion lens made of coaxially arranged apertured diaphragms (7, 8, 9) may be mounted, across which DC voltages are applied to form the potential barrier on the exit side. This potential barrier keeps the damped ions within the first storage reservoir (6). As long as the storage reservoir (6) is being filled, and the ions still have relatively high kinetic energies, this potential barrier is made insurmountable by means of higher voltages. When the storage reservoir is completely full, and after damping the ions, the lens voltages are reduced so that this potential barrier then has a relatively low overflow in its center, but one which still holds back the ions of the storage reservoir whose motion is damped. This overflow in the apertured diaphragm system (7, 8, 9) means the ions can be exported, but only when they receive a suitable kinetic energy from an axial force to overcome the potential barrier.

In the interior of the pole rod system (6), the quadrupole RF field has exactly the same cross-sectional shape along the whole length of the axis. The local reduction in its strength in the fringing field at the end of the pole rod system (6) leads to an axial component of the RF electric field, and hence to an axial field or force component of the pseudo-potential, which does not exist in the interior of the rod system. This axial force component is a function of the radius; it is not present in the axis, but increases in the outward direction as the radius increases. This means that, as their oscillation amplitude increases, radially excited ions increasingly experience the axially outward acting force component of the pseudopotential in the RF fringing field; they are driven axially outwards and, in the axial direction, they can overcome the DC potential barrier of the lens system (7, 8, 9). The ions are exported axially into the next chamber (the second storage reservoir 10). To achieve this, it is only necessary to set the potential barrier low enough that it can be overcome by the ions that are subjected to the force of the axial components of the pseudo-potential. All other ions remain in the first storage reservoir (6). Later, they can also be mass selectively ejected for an independent analysis of their concentration.

With this type of ion gate it is quite possible to achieve very good mass resolving power for the mass selective ion export. The resulting slow outflow of the ions of the selected export mass should not be regarded as disturbing the analysis procedure particularly since the outflow is essentially determined by the slow ion diffusion for the supply of exportable ions in front of the gate. A few hundred milliseconds are required to enable the majority of the ion species that has been selected to flow out. In this exporting process, it is possible to achieve a mass resolving power for the selection of R=5000 to R=10,000. This is sufficient for separating ions of one nominal mass from ions of the next nominal mass.

In tandem mass spectrometry it is not required to use such a high mass resolution for the selection since the aim usually is to fragment all ions of an isotope group. Only then is it possible to obtain a true isotope distribution in the fragment ion spectrum as well. However, such a high mass resolution can be very useful, for example, when, by selecting the monoisotopic ions of one ion species, only monoisotopic fragment ions are to be generated and measured (for more information see below). It is precisely for complex mixtures that this can be very helpful for the unambiguous identification of a substance. If, by contrast, a true isotope distribution is also to remain intact in the fragment ion spectrum, then the various ions of the isotope group can be exported one after the other and mixed again in the second storage reservoir.

The supply of ions for the export through the ion gate can also be accelerated compared to the pure diffusion motion, however. If, for example, the auxiliary electrodes described above are used for the radial excitation of the selected ions, then the selected ions in the whole storage reservoir can be uniformly excited to oscillations. Below is a description of how it is possible to limit the amplitude of these oscillations. A DC voltage can now be applied across various auxiliary electrode sections so that a slight voltage drop is generated in the interior of the storage reservoir, which drives ions forwards in the direction of the ion gate. The voltage drops here need only to be between a few tenths of a volt and a maximum of a few volts. In the axis of the storage reservoir no voltage drop arises because the whole ion cloud is shifted in such a way that every voltage drop is balanced out by space charge. Outside the axis, however, the ions are affected by the voltage drop; they are driven toward the ion gate. If the ions selected now oscillate through the axis to regions outside the stationary ion cloud, then this is where they experience the voltage drop and are driven toward the ion gate.

For the final embodiment of the ion gate there is a whole series of different subtypes which are distinguished by the device used for dipolar excitation of the selected parent ions and by the configuration of the pole rod system. They will each be briefly discussed here.

### EMBODIMENT 1

### Excitation by Split Lens Diaphragms

The apertured diaphragm of the lens system, which faces the pole rods, can be split transversely in either a linear or a cruciform shape and can also be supplied, in addition to the DC potential, with an alternating voltage which is either dipolar or circumpolar. It can thus be used for the radial excitation of the parent ions which are to be exported. There are three different forms of excitation here:

### EMBODIMENT 1A

### Excitation in the Plane through Two Pole Rods of the Storage Reservoir (“Conventional Excitation”)

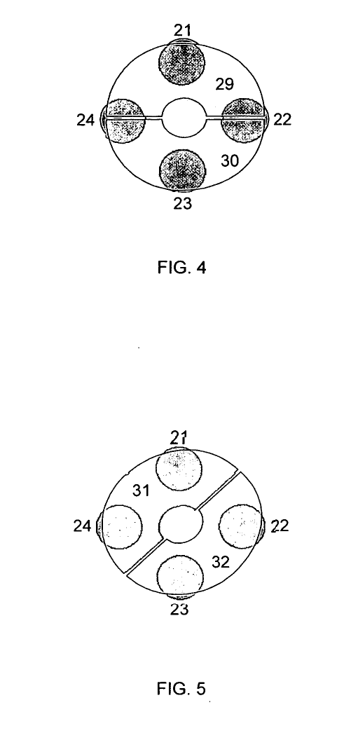

In this case, the slit of the apertured diaphragm has an orientation which is parallel to the direction between two opposed pole rods (22) and (24), as shown in FIG. 4. This form of split apertured diaphragm with the halves (29) and (30) leads to an excitation of the ions in a plane created by the two opposed pole rods (21) and (23). This excitation is sufficient for a mass selective ion export, but it is not the optimal excitation.

### EMBODIMENT 1B

### Excitation in the Plane through the Gap Mid-Way Between the Pole Rods of the Storage Reservoir (“Diagonal Excitation”)

This form of excitation has a decisive advantage over the conventional excitation method described above. A split apertured diaphragm (31, 32) is again used, but the slit of the transverse split is now in the direction of the opposing gaps between two adjacent pole rod pairs, as can be seen in FIG. 5. With this type of excitation, the ions are brought into an oscillation path where the forced oscillations of the ions which are imposed by the RF voltage across the pole rods (the “driver RF”) do not occur in the plane of the secular oscillations, but at right angles to it. This means that, in the fringing field, the pseudo-forces which act outwards are achieved at smaller oscillation amplitudes than is the case with the conventional excitation. This makes it easier to export the parent ions; the export occurs at smaller excitation voltage amplitudes and smaller oscillation amplitudes, nearer to the central overflow region of the potential barrier in the lens system.

### EMBODIMENT 1C

### Circumpolar Excitation

For this type of excitation the first apertured diaphragm requires a cruciform slit, as shown in FIG. 3, and to use a four-phase alternating excitation voltage. The four phases of the alternating excitation voltage are at 90° to each other and are applied in turn across the four quarters of the diaphragm (33, 34, 35, 36). The parent ions selected are then excited resonantly to circular trajectories with small amplitude, i.e., small radius. In this case, the pseudoforces which are sufficient to export the parent ions via the potential barrier are achieved with only very small deflections from the axis.

### EMBODIMENT 2

### Excitation by Auxiliary Electrodes Located Between the Pole Rods of the Storage Reservoir

The parent ions selected do not have to be excited by split apertured diaphragms; they can also be excited by the auxiliary electrodes (25, 26, 27, 28) which are located in the gaps between the pole rods (21, 22, 23, 24), as shown in FIG. 2. The radial, sustained excitation of the parent ions selected always involves the risk of a fragmentation, however, if it is too strong, i.e., if it leads to large and fast oscillation amplitudes. A fragmentation in the storage reservoir (6) must be avoided at all costs, however, since it goes hand in hand with an adulteration of the concentration ratios. It is only with small oscillation amplitudes that the speeds for a given ion species are slow; and only with slow collisions with the damping gas do the collisions remain elastic, i.e., they do not absorb any internal energy.

### EMBODIMENT 2A

### Limited Length of the Auxiliary Electrodes

While, in principle, the auxiliary electrodes can carry out the excitation over the whole length of the storage reservoir, it is more favorable for some applications to carry out the excitation only across longitudinally split auxiliary electrodes in the end part of the storage reservoir. The auxiliary electrodes of this section need only to have a length of roughly between 10 and 20 millimeters. Limiting the excitation to a small volume of the storage reservoir is already of benefit here in preventing a fragmentation. Nevertheless, the dipolar excitation must only be undertaken very carefully since, in principle, the amplitudes of the excited ions in resonance increase more and more and are only slowed down by collisions with the damping gas. It is therefore necessary to establish a critical equilibrium between excitation and damping.

The oscillating parent ions do not remain stationary in one place but statistically move about. If this brings them close to the end of the pole rod system, they experience the outwardly directed forces of the pseudopotential, and are exported. They therefore flow gradually out of the storage reservoir. The statistical random motion (the diffusion) is assisted by the elastic collisions with the damping gas.

This type of excitation is actually only favorable when the ions oscillate very slowly in the quadrupole field, i.e., when the ions are very heavy and when the quadrupole field has very low voltages. With this mode, it is therefore favorable to begin with the heaviest parent ions which are to be analyzed. The next heaviest ions are then analyzed. In the course of the subsequent analyses, the RF voltage can also be reduced in stages in order to always export parent ions which are oscillating very slowly. It is even possible to proceed so that the same, relatively slow excitation frequency remains set, and the ions to be excited and exported are selected by the strength of the RF field.

### EMBODIMENT 2B

### Limiting the Oscillation Amplitudes by Means of a Superimposed Hexapole Field

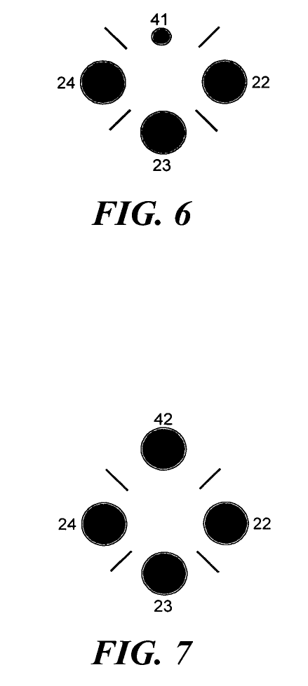

If the cross-sectional shape of the pole rod system of the storage reservoir is chosen so that it superimposes a relatively strong hexapole field on the quadrupole field (see FIGS. 6 and 7), then the secular oscillations of the ions are restricted to limiting amplitudes. The effect of the hexapole field is to make the secular frequency of the oscillating ions dependent on their amplitude; to be more precise, it gets smaller with increasing amplitude. Since the amplitude increases with increasing resonant excitation, the secular frequency of the oscillating ions is shifted and the ions quickly fall out of resonance. Their amplitude no longer increases. If the phase of the excitation frequency has then turned by more than 90°, there is even a reduction of the oscillation amplitude until the state of a resonant increase is again attained. The oscillations of the resonantly excited parent ions therefore have limited amplitudes, whose magnitude is a function of the strength of the superimposed hexapole field, i.e., of the form and positioning of the pole rods, as represented in FIGS. 5 and 7. If the excited ions now move into the fringing field at the end of the pole rod system, then they briefly experience a weaker radial pseudopotential which brings them back into resonance and briefly increases their amplitudes. But they are then immediately exported, as a result of the growing axial component of the pseudopotential, into the second, adjacent storage reservoir. It is advisable here to superimpose a relatively strong hexapole field so that the oscillations of the parent ions remain small. A hexapole field can also be electrically superimposed if the two RF voltages of the same phase, which are applied across two opposed pole rods, have different amplitudes. It is thus possible to adjust the strength of the hexapole field.

It can also be favorable here to excite the ions with the auxiliary electrodes only at the end of the storage reservoir. On the other hand, it is interesting to create the excitation in the whole storage reservoir and to drive the ions with limited oscillation to the ion gate, as described above, by means of a voltage drop across the auxiliary electrodes to achieve a faster emptying of the storage reservoir for these selected ions. The voltage drop across the auxiliary electrodes can be generated by split sections of the auxiliary electrodes, and also by a voltage drop along wire-shaped auxiliary electrodes made from high resistance material. The considerations concerning the sequence when selecting the parent ions are the same as those stated for embodiment 2a.

### EMBODIMENT 2C

### Limiting the Amplitudes with a Superimposed Octopole Field

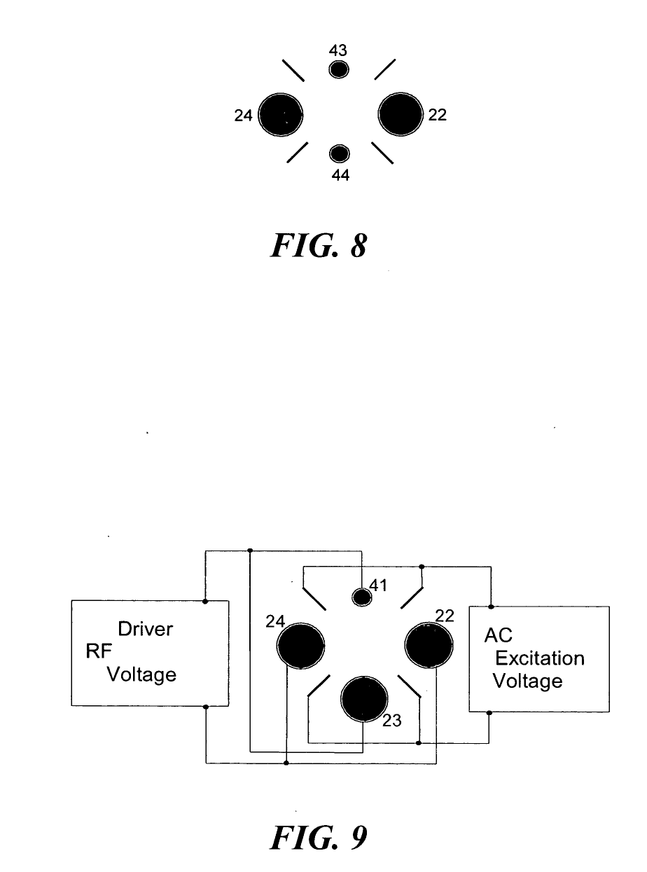

Similarly, an octopole field can be superimposed on the quadrupole field by the form or positioning of the pole rods, one example of which is shown in FIG. 8. If this octopole field is strong enough, the amplitudes of resonantly excited ion oscillations are again limited. The limiting of the excitation of oscillations occurs in one of the two planes between two opposed pole rods by reducing the secular frequency (plane through pole rods 24-22), and in the other plane (through pole rods 43-44) by increasing the secular frequency. The effect is first noticeable when the ions migrate into the fringing field. In one case the amplitude in the fringing field is temporarily increased, in the other case it is decreased. Both directions can be used to limit the amplitude. The octopole field cannot be made electrically adjustable, it can only be generated by changing the form of the pole rods.

### EMBODIMENT 2D

### Use of the Nonlinear Resonance

The superpositions with hexapole or octopole fields also generate nonlinear resonances which occur when the secular frequency of the ions is just at an integral fraction of the frequency of the driver RF voltage. The first nonlinear hexapole resonance lies at a third of the frequency of the driver RF voltage, and the first octopole resonance at a quarter of this frequency. Toward smaller fractions the nonlinear resonance decreases greatly. In such a nonlinear resonance only a very low excitation voltage of the dipolar excitation is needed for the ions to experience this nonlinear resonance, which acts only outside the axis and increases toward the outside. The ions are then gripped by this resonance and automatically oscillate until their amplitude is limited by the shifting of their secular oscillation frequency described above. The resonances at a third or a quarter of the RF unfortunately have very high oscillation frequencies; there is therefore always the danger here that the ions will be fragmented unless extremely small amplitudes are used. The resonances at much smaller fractions of the driver RF are, by contrast, much weaker and less pronounced. All these resonances are self-sustaining: ions which oscillate in resonance with maximum amplitude are kept in resonant oscillation by the dipole field even when the external excitation is switched off, because this oscillation is fed by nonlinear phenomena from the driver RF voltage.

It can also be favorable for all the previously stated embodiments 2b to 2d if the sections of the auxiliary electrodes which are used for the excitation are only relatively short and reach almost, but not completely, to the end of the pole rods. Diffusion causes the parent ions from the remaining part of the storage reservoir to move constantly into this part, and they are also excited here. However, for the embodiments 2b to 2d, in which superpositions with higher order fields are used, these superpositions with higher multipole fields, and the exciting auxiliary electrodes, can also extend over the whole length of the storage reservoir, in which case the excited ions can be driven to the ion gate by a voltage drop across the auxiliary electrodes.

However, by configuring the pole rod system accordingly, it is also possible for the superpositions with higher multipole fields and the exciting auxiliary electrodes to be formed only at the end of the pole rod system. For the excitation in the embodiment 2a, a diagonal or circumpolar excitation is again very favorable; in the embodiments 2b to 2d these forms of excitation are of no consequence since the favorable excitation directions depend on the direction of the superimposed high multipole fields.

As has already been stressed several times, for an axial export, the excitation of the ion oscillations transverse to the axis of the rod system should not be large, in order to avoid fragmentation of the ions. For a good mass resolved export, it is sufficient that the oscillations only reach out some two to three millimeters to each side of the axis. As noted above, it is favorable to allow the ions to oscillate slowly, either by selecting ions which are sufficiently heavy or by choosing a low RF voltage.

In an arrangement in which the pole rods are arranged in a distorted geometry compared with usual rod geometry, or have different thicknesses, causing a nonlinear radial increase of the pseudo-potential in the interior, an ion species can be excited to oscillations with a limiting amplitude. If long auxiliary electrodes are used which extend over the whole storage reservoir, then all ions excited in this way oscillate in the storage reservoir. In this case, the ions selected can be driven to the ion gate in a few tens of milliseconds by a voltage drop along the auxiliary electrodes.

As already described above, it can also be better (and simpler), however, to not allow all selected parent ions to oscillate at the same time but only the parent ions in the last part of the storage reservoir. Since the ions are not stationary in one place but move, by diffusion, in the longitudinal direction, they also enter the fringe field at the end of the storage reservoir and are then exported through the ion gate into the second storage reservoir. It is as if these ions continuously flow out of the storage reservoir. This export of the parent ions occurs continuously by leaving the radial excitation switched on over a long period. The time over which the ions flow out depends on the length of this storage reservoir; for the dimensions given above there is a half-life in the order of a hundred milliseconds. If all the ions are sent backwards and forwards in the storage reservoir by slight AC voltages across different sections of the auxiliary electrodes, then the outflow of the excited parent ions can be accelerated a little.

If the storage reservoir is filled with a large number of ions, then the prevailing space charge means that only a moderate mass resolution of the mass selective ion export through the ion gate can be achieved, usually limited to a few atomic mass units. The mass resolution can be improved by setting up a second ion gate in the second ion reservoir, however. In this case, the second storage reservoir is again designed as a quadrupole rod system, but one which is never filled as full as the first storage reservoir, because only a very small fraction of the ions ever possess the export mass selected. At the end of this second reservoir, which can be much shorter than the first storage reservoir, is the second ion gate, which now has less interference from space charges and hence has better mass selection. The two ion gates can also operate at the same time. If the ions desired for the analysis are transferred into a third storage reservoir, then the remaining ions of the second storage reservoir can be fed back into the first storage reservoir by lowering the voltage barrier and setting the axial potentials accordingly. Ions are then theoretically never lost. This process can be repeated as often as required for the same charge-related mass or also later for another mass.

A tandem mass spectrometer of this type with at least three storage reservoirs and two ion gates can be used not only to increase the mass resolution of the mass selective ion export, but also to generate granddaughter ions, i.e., fragment ions of the second fragmentation generation. It is thus possible, for example, to feed the ions which have been selected well according to their mass from the third storage reservoir back into the second storage reservoir after it has been drained. They can then be fragmented in this second storage reservoir by radial resonant excitation, for example, as described in detail below. The collisionally induced fragmentation can also be achieved if the potential on the axis in the reservoirs imparts a suitable kinetic energy to the ions when they are being guided from the third storage reservoir back into the second. Other fragmentation mechanisms are also possible, as described in more detail below. It is now possible to transfer one ion species from the mixture of fragment ions mass selectively through the second ion gate into the third storage reservoir, fragmenting them either in this transfer process or in this third storage reservoir, and then measuring them with the mass analyzer as a granddaughter ion spectrum.

Thus, a particularly favorable tandem mass spectrometer according to this invention has not only one ion gate but two, arranged between suitable storage reservoirs.

A completely different embodiment of a mass selective ion gate also uses a storage reservoir in the form of a quadrupole rod system. In this case, however, one of the pole rods is equipped with a long slit from which the parent ions selected can be ejected into an ion funnel by a dipolar resonant excitation. A gas-filled ion funnel captures the parent ions and guides them into a second storage reservoir.

This mass selective ejection of the parent ions functions particularly well if the ejection is carried out under conditions of nonlinear resonance. This requires that the arrangement of the pole rods, which can be round or preferably hyperbolic, is distorted so as to be slightly asymmetric, for example by positioning only one single pole rod slightly further from the axis, so that a slight hexapole field is superimposed on the quadrupole field which is created in the interior of the rod system. This produces a nonlinear resonance for those ions whose secular oscillation amounts to just a third of the RF voltage applied across the pole rods. The asymmetric distortion with the superimposed hexapole field also impedes the growth of the amplitude, however, because the oscillation frequency is now a function of the amplitude of the oscillation. To compensate for this effect, a further multipole field of a higher order, for example an octopole field, must also be superimposed, since this enables the frequency shift caused by the hexapole field to be compensated to a certain degree. This makes it possible to achieve a very good mass selective ejection of the parent ions selected.

To eject the parent ions, the RF voltage is now removed from the opposed pair of rods that also contains the rod with the slit. (It is preferable if half the single-phase RF voltage is now applied to both ends of the apertured diaphragms). The RF voltage across the two remaining pole rods, which is now only single phase, is now set so that the parent ions selected just oscillate at a third of the RF. A very slight alternating voltage with the frequency of a third of the RF is now applied in phase opposition across both voltage-less pole rods. This brings about a very gentle dipolar excitation of the secular frequency of the parent ions which are practically at rest in the axis. They begin to oscillate and thus pass into the influence sphere of the nonlinear resonance and leave the storage reservoir through the slit in the pole rod. The combination of hexapole field and octopole field makes the ejection strictly one-sided. In spite of its high ejection speed, this ejection results in a very good mass resolution of the selection. It is advisable to begin with the lightest of the parent ions to be analyzed since these form the finest ion string close to the axis. For the transition from one species of parent ion to the next heaviest, it can even be advisable to eject all ion species of the intervening masses in order to always eject the lightest ion species of the reservoir.

An unfavorable aspect of this ejection is the relatively high kinetic energy of the ions ejected, consisting of a minimum energy of a few hundred electron-volts and an unfortunately wide distribution of the kinetic energies. The minimum energy here can be relatively easily removed by an opposing electric field, but the excess energy can only be destroyed by collisions with a damping gas. It is unavoidable that some of the ejected ions are already fragmented. It is therefore favorable to already use the interior of the collecting ion funnel as the collision chamber for fragmentation.

We now return to the axial export. The mass selected ions, which are collected in the second storage reservoir, are now to be fragmented. One way of achieving this is to inject them in the usual way, with a collision energy of 30 to 100 electron-volts, into a fragmentation chamber, which again can be designed as a quadrupole rod system. The fragmentation chamber is also filled with a damping gas, which here acts as the collision gas for the fragmentation. It is quite possible to again use helium at the same pressure as in the storage reservoir, so that the pressure is uniform from the first storage reservoir to the collision fragmentation chamber. The pressure can be maintained by a gas container (18) and a pressure reducing feed.

It is quite acceptable for the fragmentation chamber to be identical to the second storage reservoir (10). The ions are then already accelerated to an adjustable 30 to 100 electron-volts as soon as they leave the first storage reservoir (6) through the ion gate; these 30 to 100 volts must be set between the potential barrier of the ion gate and the potential on the axis of the second storage reservoir (10). If two ion gates are arranged one behind the other to improve the selection of the parent ions, then the third storage reservoir can serve as the collision chamber.

The fragmentation can also be undertaken in the second storage reservoir (or in a further one) by a radial dipolar excitation of the parent ions. This excitation requires times of a few tens of milliseconds to approx. a hundred milliseconds for a fragmentation, since many collisions are required before sufficient energy for a decomposition is absorbed. This type of collisionally induced fragmentation is, however, particularly favorable because, in the main, only direct daughter ions are generated, and no granddaughter ions, as, after the decomposition of the parent ions, the daughter ions are no longer in resonance with the exciting dipole field and are immediately damped and cooled by the collision gas.

There are quite different types of fragmentation which can also be used here. The parent ions selected can be fragmented in the fragmentation chamber in a known way by irradiating them with an infrared laser (IRMPD), by electron capture (ECD), by bombardment with highly excited neutral particles from a FAB particle source (FAB=fast atom bombardment) or by electron transfer by negative ions (ETD).

For all these methods it is again favorable if the fragmentation chamber (10) is a quadrupole or a hexapole rod system which is charged with a damping gas. The fragment ions then collect in the longitudinal axis of this chamber (10) and can be introduced as a fine ion beam into the mass analyzer through narrow terminal apertured diaphragms (11), which also act as pressure reducing stages.

An outstanding mass analyzer for these purposes is a time-of-flight mass spectrometer with orthogonal ion injection. The ions are injected into the pulser (12) of the time-of-flight mass spectrometer in the form of a very fine beam and are preferably monoenergetic. The pulser then periodically pulse ejects a section of the ion beam into the drift region of the time-of-flight mass spectrometer at right angles to the previous direction of flight with a frequency of around 10 to 20 kilohertz. The ions separate according to their charge-related mass because the speeds of the various ion species are different. The ions then enter an ion reflector (13), which reflects them onto an ion detector (14). This brings about a spatial and energy focusing which results in a high mass resolving power. In the ion detector, the ion currents of the individual ion species are amplified and then fed via an electrical post-amplifier to a transient recorder, which digitizes each of the ion currents in around half a nanosecond and synchronously adds the values to the values of the previously scanned spectra, which were scanned in phase. Individual spectra of 50 to 100 microseconds in length are thus measured. This produces sum spectra which, in commercial instruments, comprise around 128,000 or even 256,000 ion current values, for example.

In commercially available desktop instruments, these time-of-flight mass spectra exhibit mass resolutions of m/Δm=15,000 and mass accuracies of around 3 ppm (parts per million). The pulser operates at around 15 kilohertz if the accelerations in the pulser are around 8 to 10 kilovolts. Fifteen thousand mass spectra are therefore generated and added per second. In the pulser, a large number of ions of the fine ion beam are collected and periodically pulse ejected; good time-of-flight mass spectrometers have duty cycles for the ions of the ion beam in the order of some 50 percent of the ions injected. If the additions are terminated after 1500 spectra, then ten sum spectra per second can be supplied. These instruments can also be used for tracking rapidly changing processes; they use a large proportion of the ions of the ion beam provided and they have an adjustable dynamic range of measurement thanks to the adjustable number of the added mass spectra.

If higher mass accuracies are required, the time-of-flight mass spectrometer can be replaced by an ion cyclotron resonance mass spectrometer. This usually operates with a magnetic field generated by superconducting magnetic coils. There are instruments with seven, nine; eleven and fifteen Tesla; the mass accuracies can be considerably better than a millionth of the mass. These FTMS mass spectrometers operate relatively slowly, however; they only just meet the definition of a “fast” mass spectrometer.

Other types of mass spectrometer can also be used. If, for example, a quadrupole mass spectrometer is used instead of the time-of-flight mass spectrometer, then one obtains a modification of a so-called triple quad instrument, so named because of the three successive quadrupole rod systems. The first rod system in the triple quad acts as the mass filter to select the ions, the second as the fragmenting quadrupole, and the third as the mass analyzer for the fragment ions. According to the invention, the selecting mass filter, which destroys all ions that are not involved in the analysis, is then replaced with a more economical system with a mass selective ion gate. This instrument is not ideal as intended in the invention, however, because the mass filter as the mass analyzer only just meets the definition of a “fast” mass spectrometer and because the mass analyzer again operates very uneconomically.

The first storage reservoir can also be designed in a completely different way, however. It is thus possible to produce a thick cylindrical chamber with two hemispherical terminals made from two wire coils wound as a double helix, the two RF phases being connected to the two wire coils. Holes are left free at both ends for injecting and extracting the ions. It is best if the extraction hole is closed by a quadrupole rod system which then ends in an ion gate of the type described.

The tandem mass spectrometer can also be equipped with a further device for generating granddaughter ions, as already described above. This essentially requires that the first fragmentation device is followed by another ion gate, which is used to select a specific species of daughter ion. The daughter ions selected are then fragmented into granddaughter ions in a second fragmentation device. The mass analyzer then acquires the granddaughter ion spectrum. The second fragmentation stage considerably increases the selectivity of the method and hence the identification certainty. The other daughter ions, which have not been selected, remain in the first fragmentation device and can also be analyzed in subsequent stages, again after selection, by further fragmentation. If there are two ion gates between three storage reservoirs, it is possible both to increase the mass resolution for the ion export and also to export one species of fragment ion for acquiring granddaughter ion spectra by moving the ions backwards and forwards between the storage reservoirs as necessary. With three ion gates between four storage reservoirs it is also possible to acquire great-granddaughter ion spectra without losing other daughter or granddaughter ions.

To illustrate one method for the application of the novel tandem mass spectrometer, we shall consider the analytical objective of measuring the relative concentrations of around 20 different types of protein in a tissue consisting of only very few cells. For this purpose, the proteins of these cells are lyzed using well-known methods. A known quantity of a reference protein is now added to the lysate. This later serves as the concentration reference, and also serves to monitor the method as a whole. The analyte proteins (including the reference protein) should all have hydrophobic affinity. These can therefore be extracted from the lysate in a first stage by means of a wide-band extraction in order to reduce the complexity of the mixture. This can be brought about through magnetic nanoparticles, for example, whose surface is affinitively activated by a hydrophobic coating. We will not go into details here, as the specialist is aware of them. A second reference protein can then again be added to the extract. There are broadband extraction methods for a wide variety of substance groups of mixtures, for example for anion peptides, cation peptides, phosphorylated peptides and many more.

The solution with the extracted analyte proteins can now be digested with an enzyme, for example trypsin, to obtain digest peptides which can be analyzed in the limited mass range between approx. 100 and 4,000 atomic mass units. The digest peptides of the analyte proteins must be precisely known in this case. The dissolved mixture of the digest peptides, which is only a few microliters of solution, is now filled into a nanospray capillary and sprayed through an electric field with negative attracting voltage; after the droplets have vaporized, the digest peptides are almost 100 percent positively ionized. Around 10⁸ ions of the digest peptides from the extracted proteins can thus be produced from a very low number of cells, in the limiting case from a single cell. Incidentally, most of these ions are doubly positively charged.

With modern means, some ten percent of these ions, i.e., 10⁷ ions, can be stored in the storage reservoir. Since some digest peptides, but not those which belong to the analyte proteins, occur extremely frequently, they can be ejected from the storage reservoir by exciting their secular oscillations with the aid of the auxiliary electrodes. Some 10⁶ ions should then remain in the storage reservoir, a quantity which is favorable for the subsequent analyses.

Beginning with the heaviest species of digest peptide ions, selected ion species of the analyte substances and reference substance are now analyzed individually one after the other. It is preferable to use the doubly charged ions of selected digest peptides of these substances. These doubly charged ions are exported, in the way described, through the ion gate into the fragmentation chamber, where they are fragmented with one of the available types of fragmentation. The fragment ions are measured in the time-of-flight mass spectrometer as a fragment ion spectrum.

The ions of the digest peptides of a complex mixture generally populate all masses of the mass range many times over. It is known that singly charged digest peptide ions form a cluster, which is around 0.3 atomic mass units wide, at each mass number. Doubly charged ions form a cluster which is 0.15 mass units wide around half integer mass values. If one therefore selects the monoisotopic ions of a digest peptide with unity resolution (one integer mass number is separated from the next), then a superimposition of several ions with the same mass number but different identities must be expected. To increase the selectivity, the fragment ion spectra are therefore measured, since these are largely unique to each digest peptide, similar to a fingerprint. Since the fragment ion spectra superimpose when several digest peptides are fragmented simultaneously, the known fragment ion spectrum of the digest peptide of analytical interest must be filtered out with known mathematical methods.

The term “monoisotopic” ions of the digest peptide means those ions of the isotope group which consist only of ¹²C, ¹H, ¹⁴N, ¹⁶O, ³²S and ³¹P. If they are selected well separated from the other ions of the isotope group, and then fragmented, the fragment ion spectrum of these monoisotopic ions consists only of single lines and no longer of isotope groups. This effect can be put to good use in the filtering process since most of the superimposed ion species are not monoisotopic ions and appear after the fragmentation as (usually strangely distorted) isotope groups.

For organic substances, the monoisotopic ion signal is the strongest signal up to a molecular weight of m<2200 atomic mass units, the choice of the monoisotopic ions is therefore particularly favorable here. In the adjacent region of the molecular weights from m=2200 up to m=3300 atomic mass units, the ion signal of the ions which contain a ¹³C is the strongest signal. If these ions are exported and fragmented, a fragment ion spectrum from two ion signals per isotope group with easily predictable intensity ratios is obtained. This fragment ion spectrum can therefore also be easily identified and used for an analysis. Similarly, this also applies to ions which contain two or more ¹³C atoms, but it becomes more and more complicated to interpret the fragment ion spectra. However, it is by no means always necessary to strive for a true isotope distribution in the fragment ion spectrum by exporting and fragmenting all isotope signals of an isotope group.

This analytical process is then conducted for all known digest peptides of all analyte proteins and reference proteins. This means that for the 20 analyte proteins it is quite likely that between around 100 and 200 digest peptides must be analyzed. Summarizing these results provides a high degree of certainty for the quantitative analysis of the analyte proteins, however. The analytical method here must be calibrated beforehand with known mixtures of the same proteins, as is always necessary in analytical chemistry.

Furthermore, the analytical process is very fast. If both the extraction time and the analysis time for every digest peptide are set at a complete second, then the whole analytical process takes only between approximately 200 and 400 seconds for the 100 to 200 digest peptides, plus the ionization time of around three minutes. The analysis therefore takes around eight minutes. This analysis time is very short when compared with an analysis which requires that a substance be separated by liquid chromatography or capillary electrophoresis. If the first storage reservoirs are double, for example as described in German patent application DE 10 2004 028 638.8-54, the time can be shortened.

If only a small number of substances in favorably prepared samples are to be quantitatively measured via granddaughter ion spectra, then the invention presented here can be used to develop methods for this which only take a total of two to three minutes and which manage without any type of chromatography at all.

Protein mixtures can also be measured without enzymatic digest, of course. In this case, the time-of-flight mass analyzer must be set to a high mass range of a few 100,000 atomic mass units. Charge stripping may be a favorable option here.

A further method can, for example, identify the proteins which are to be found in a 2D gel in a largely separated state, as so-called “spots”. The stained spots are punched out, subjected to an enzymatic digest of the protein, and the digest peptides are subsequently eluated out of the gel. A few microliters of the eluent are introduced into the capillary of a nanoelectrospray ion source; the ions are stored in the storage reservoir. A small representative fraction of the ions from the storage reservoir is now fed to the time-of-flight mass spectrometer, without being selected or fragmented, to obtain an overview of the masses of the digest peptide ions present. The ions of the digest peptides are then individually exported and fragmented in accordance with the invention. The fragment ion spectra serve in the usual way to identify the protein in the spot by feeding the spectra to the known search engines for comparisons with protein sequence databases. Automated methods require only a few seconds, for example only around ten to thirty seconds, for identifications of this type including the ionization and the scan.

The instrument and method can be used in a wide variety of applications. The method with its many modifications can be used, for example, in cell biology research, in medical diagnostics with biomarker proteins, in clinical studies for pharmacokinetics, and in many other analyses conducted both for research and routinely to determine the concentrations of substances in complex mixtures.

What is claimed is:

1. A tandem mass spectrometer, comprising:
a) an ion source to ionize a sample,
b) a storage reservoir to store the ions of the sample,
c) means to stop further influx of ions into the storage reservoir,
d) an ion gate operating after influx of ions into the storage reservoir has been stopped in order to export ions of a selected mass range from the storage reservoir without damaging ions remaining in the storage reservoir,
e) means to fragment the exported ions, and
f) a mass analyzer to acquire fragment ion spectra.

2. The tandem mass spectrometer according to claim 1, wherein the mass analyzer can acquire at least substantially one mass spectrum of fragment ions per second with a mass resolution of at least R=m/Δm>6,000.

3. The tandem mass spectrometer according to claim 1, wherein the ions of the sample are generated outside a vacuum system of the mass spectrometer and the ions are transferred, together with an ambient gas, into the vacuum system of the mass spectrometer, and wherein the means for stopping the influx of further ions into the storage reservoir also stops the flow of the ambient gas into the vacuum system of the mass spectrometer.

4. The tandem mass spectrometer according to claim 1, wherein the storage reservoir comprises a quadrupole rod system operated with RF voltages, and means for causing dipolar resonant excitation of mass specific ion oscillations.

5. The tandem mass spectrometer according to claim 4, wherein the ion gate is disposed at one of an location inside the quadrupole rod system and at the end of the quadrupole rod system in order to allow for axial exportation of ions of a selected mass range.

6. The tandem mass spectrometer according to claim 5, wherein the ion gate is located at the end of the quadrupole rod system and a fringing field of the quadrupole rod system causes axial exportation of ions of a selected mass range.

7. The tandem mass spectrometer according to claim 4, wherein the means for causing dipolar resonant excitation of mass specific ion oscillations excites the ions in a direction of the opposing gaps between two adjacent pole rod pairs of the quadrupole rod system.

8. The tandem mass spectrometer according to claim 4, wherein the quadrupole rod system generates an RF quadrupole field and wherein multipole fields of higher order are superimposed on the RF quadrupole field in the quadrupole rod system.

9. The tandem mass spectrometer according to claim 4, wherein the quadrupole rod system has a longitudinal direction and comprises a plurality of pole rods and a plurality of auxiliary electrodes located between the pole rods, each auxiliary electrode being divided in the longitudinal direction into sections which are insulated from each other.

10. The tandem mass spectrometer according to claim 9, wherein only the auxiliary electrode sections nearest an end of the quadrupole rod system are charged with RF voltages to excite ions.

11. The tandem mass spectrometer according to claim 1 comprising at least one additional storage reservoir and at least one additional ion gate located in a path followed by ions between the first storage reservoir and the mass analyzer.

12. The tandem mass spectrometer according to claim 11, wherein the storage reservoir and the at least one additional storage reservoir comprise quadrupole rod systems.

13. A method for the analysis of analyte substances in a complex mixture, comprising:
(a) ionizing a sample of the complex mixture to generate sample ions,
(b) storing the sample ions in a storage reservoir,
(c) stopping the influx of further ions into the storage reservoir,
(d) after influx of further ions into the storage reservoir has been stopped, exporting a selected ion species of one of the analyte substances from the storage reservoir through an ion gate, whereby the ions remaining in the storage reservoir are left undamaged,
(e) fragmenting the exported ions,
(f) acquiring a mass spectrum of the fragment ions, and
(g) repeating steps d) to f) for other ion species in the storage reservoir.

14. The method according to claim 13, wherein step (a) comprises ionizing a sample of the complex mixture outside of a vacuum system connected to the storage reservoir and introducing sample ions into the vacuum system via a port, and wherein step (c) comprises closing the port.

15. The method according to claim 13, wherein undesired ion species are removed from the storage reservoir during step (b) or after step (c).

16. The method according to claim 13, wherein step (d) comprises exporting the selected ion species into a second storage reservoir, and exporting a second selected ion species from the second storage reservoir through a second ion gate and wherein step (e) comprises fragmenting the ions exported from the second reservoir.

17. The method according to claim 13, wherein step (e) comprises fragmenting the exported ions into daughter ions, mass selectively exporting a selected species of daughter ions and fragmenting the exported daughter ions into granddaughter ions, and wherein step (f) comprises acquiring the mass spectrum of the granddaughter ions.

18. The method according to claim 13, wherein the analyte substances include a reference substance of known type and concentration, to whose measured frequency the measured frequencies of the other analyte substances can be related.

19. An ion gate for the axial export of ions of a selected mass range from a storage reservoir formed by a quadrupole rod system comprising:
means for causing dipolar resonant excitation of mass specific ion oscillations in a direction of the opposing gaps between two adjacent pole rod pairs of the quadrupole rod system, and
means for exporting ions oscillating in the direction.
